(19) United States
(12) Patent Application Publication
(10) Pub. No.: US 2002/0103701 A1
(43) Pub. Date: Aug. 1, 2002

(54) System and method for developing a variable television production, including material to promote multiple members of a cooperative

(76) Inventor: Craig Mowry, Southampton, NY (US)

Correspondence Address: Craig Mowry, 95 South Main St., Southampton, NY, 11968, US

(21) Appl. No.: 09/774,048

(22) Filed: Jan. 31, 2001

(51) Int. Cl. G06F 17/60

(52) U.S. Cl. 705/14

(57) ABSTRACT

In the context of a television commercial with one concept, storyline, and storyboard (planned visuals and audio sequencing,) a variable commercial is produced with a virtually exponential number of potentially edited versions, to accommodate the promotions of multiple entities, or brands. The brands and entities, potentially being the members of an industry cooperative, such as a guild or product-venue affiliation.

In filming or digitally originating (or video-graphing,) a single television commercial, selected “scenes,” or planned visuals within the commercial, are shot multiple times, varying only selected promoted items within the visual.

BRAND name manufacturers of items desirous of being included within the cooperative commercial program, would supply selected item(s) to the commercial production, for inclusion during the shooting of the television commercial, (the origination of visuals.) Selected scenes, (single visuals defined by a changing of camera position or vantage point,) are set up and photographed (or video-graphed,) as many times as there are BRAND name products for inclusion in the commercial potentially. Meaning, if there are 2 brands of rings, 1 necklace brand and 1 bracelet brand, these 4 items would be included individually in “retakes” of each scene within the commercial where products to be promoted are determined to be featured.

In editing, retail establishments, (as an example of one potential “end user” of versions of the commercial,) may request specific versions of the commercial: Such as, please put brand 1 in the first product shot, brand 3 in the second and brand 4 in the third, in a commercial that features three product shots in total. As a result, the versatility of end-users being able to dictate the promoted items to be within their particular version of the same commercial allows for more versatile and advantageous regional placement of a commercial that can simultaneously promote a retailer, the brands featured and an affiliation, or larger entity to which the brands and/or retailers belong, such as a guild or marketing group.

### SUMMARY OF THE INVENTION

In a number of industries, several levels of entities requiring individual promotion must function in tandem to get products made, distributed to regions, sold and promoted to the public toward those sales. Such industries include the JEWELRY industry, the FASHION industry, the BEAUTY industry, among countless others involved in the coordination of particular venues of products and services and getting those products and services in to common areas where consumers at the local level can find and purchase them.

The present invention provides a television promotion cooperative that expands versatility and “overlap” in the advertising of products, distributors or retailers and even guilds or industry consortiums and groups, through. This cooperative, which involves a system and method involving controlled aspects of production and digital non-inear editing, provides final products in the form of final video material that any one, or all of the members of the cooperative would have a vested interest in seeing aired, cablecast or Webcast in selected regions of importance to those members.

The cooperative production approach of this invention includes the inclusion of multiple products, or brands, which come from the “suppliers” of the industry of which the cooperative members are conducting business. These products or brands will simply be referred to as the BRANDS.

The distribution points, which are often retail stores, of these BRANDS, in the local markets where products and services are distributed, will be referred to as DISTRIBUTORS.

Guilds, or industry groups of which BRANDS and/or DISTRIBUTORS are members will be called GROUPS. These groups are often marketing entities designed to promote an industry as a whole, driving the overall mission and sales of that industry, or subsets of an industry: For example, the PLATINUM GUILD is a fashion accessory focused guild, promoting distributors and brands of jewelry that sell or involve PLATINUM. This guild is a subset of the JEWELRY AND ACCESSORY industry.

In shooting, whether filmed or digitally originated, a selected television commercial concept allowing for several of the commercial images to feature BRANDS may be shot more extensively with a selected number of brands or EVERY BRAND belonging to, or associated with, a GROUP to be shot in each of the said commercial images, the resulting footage from the shoot will include the potential of a multiple number of “versions” of the same commercial concept to be assembled in editing: These versions would differ from each other potentially only in the BRANDS that are featured in the commercial images. The “commercial” will be referred to as the SPOT. Every saved but of footage from the shoot featuring a brand's product, will be referred to as a TAKE. VERSIONS refers to the final form of a SPOT edited for the shoot footage, incorporating a particular combination of takes featuring group brands.

For example: Three women at a table are opening packages from a shopping spree they just were on together; spot shot “1” features images of the three women at the table; shot 2 features images of woman on the far left opening a box with a piece of jewelry in it; shot 3 features images of the woman on the right side of table's reaction; shot 4 features images of the woman in the center holding up an item she has just unwrapped from it's package; shot 5 features the woman on the right modeling an item she has just put on, whether ring, necklace or bracelet; shot 6 show a final shot of them all laughing and enjoying their purchases. If the GROUP includes thirty participating BRANDS, for instance, all 30 brands would provide at least one product each, for the shoot. Each brand would have a product featured in at least 30 takes of shots 2, 4 and 5. There is virtually an unlimited number of versions that could be created, should BRANDS provide and be featured in more than one take of each of the shots, 2,4 and 5, with other products from their inventories, adding the versatility of not only multiple BRAND combination options, but multiple product styles of each BRAND, being selectable im assembling a commercial version.

In non-linear editing, each take that was taken of products during the shoot, would be digitized and stored in a digital memory facility of an image processing unit, such as that familiar to non-linear editing suits, and catalogued according to which of the shots in the spot, (2,4 or 5,) it was, which BRAND it is, and which product style is in the take. For example, a version might be assembled as B12A/B3C/B29B. This coding would refer to BRAND 12 and the product shot that has “a” assigned to it, and as the first number listed, that is shot 2. The B3C would be for shot 4. The B29B would be for shot 5. As a such items were shot in each of those three shots, they are interchangeable; if they had not been shot as such, two brand items desired for a version might have been shot in only one of the spot shots, 2,4 or 5, creating a logistical problem in the concept and flow of the commercial, which should be consistent regardless of the version assembled. A final version may be distributed on any video or digital storage medium, such as tape or CD, or distribution to video distribution points for broadcast, cablecast or webcast; likely is the direct transmission of spot versions in the near future, involving satellite, coaxial or fiber optic transmission of data providing high resolution versions of the spot to said video distribution points electronically and without delay on digital editing assemblage of ordered spot versions.

A further aspect of the coop spot that is preferred, is an actual shot personally relevant to the DISTRIBUTORS, such as an image of their store-front, or other branding image relevant to their own promotional needs beyond the BRANDS selected for the VERSION. This final shot, shot 7 for instance, becomes the final variable on the assemblage of a VERSION, for example.

In editing, the format of the video image is important. In a preferred configuration of the present invention, the video image, based on a 1:33-1 standard television proportion, would involve a rectangular image area that is “letterboxed,” or occupying a 1:85-1 proportioned image area floating center of the video image, and bleeding (flush to) the left and right sides, familiar to letterboxed television material. Naturally, other proportions are options for the letterboxed image area. The margins TOP and BOTTOM, would be used for logo or text material, discreetly featuring the name and or logo of the DISTRIBUTOR and/or GROUP throughout the duration of the final spot version; or for any time frame desirable in the version. This use of the “margins” created by the letterbox, provides for variable BRANDS to be promoted, while the DISTRIBUTOR and/or GROUP is consistently promoted simultaneously on-screen.

The final number of versions a commercial created based on this cooperative approach would be at least: The number of items shot in each scene, multiplied by the total number of scenes which feature changeable items, multiplied by 2: This equation accounts for items not being repeated within a single edited version of the commercial.

### A System and Method for Developing a Variable Television Production, Including Material to Promote Multiple Members of a Cooperative

### PREFERRED CONFIGURATION OF THE PRESENT INVENTION

This invention and method relates to cooping advertising in a new way, that allows for multiple brand promotion within a single production endeavor. This approach will increase marketing efficiency, and allowing smaller firms to be able to enjoy the option of creative work (art,) whether print, television or other, typically only within reach of firms with very large advertising and marketing budgets. This invention also relates to redirecting advertising media that conventionally occurs on a national basis to occur on a more regionalized basis, even if the combination of those individual regions totals the entire country, for example. Today, many smaller retailers and local businesses are competing in their markets with large, franchised brands with enormous marketing resources and visibility. Though an individual “store” that is part of the franchised chain may in fact be much smaller than a single property competitor in a market, the benefit of large national promotions by a parent company, provides production quality and marketing that is beyond reach of local businesses alone typically.

I will use a filmed television commercial as the example of this method, as these filmed productions are typically out of reach financially for smaller, regional companies, interested in advertising. I will also use a scenario of INDEPENDENT JEWELRY STORES, as the example of the preferred configuration of the present invention, although whether clothing stores, hardware stores, florists or a myriad of other venues of business that occur in different regions as different storefronts and businesses, the following method could apply. Further, whether TV, print (magazine or newspaper,) radio, or other advertising venue, the method of the present invention could apply, allowing for an increased potential quality level of creative featured in advertising on a regional basis, and a potentially enhanced branding effect on the products and firms featured within the advertising.

A filmed television commercial the staple of network television advertising for instance, can cost many hundreds of thousands of dollars. For commercials shot for national broadcasting and cablecasting, costs from several hundred thousand dollars, to millions, is the rule. In many industries, such as JEWELRY, both most of the brand names of product available as well as the individual, regional retailer, are not in a position to produce the level of quality creative appropriate for their marketing. Although smaller firms, the are often precluded from adding types of media, such as television, to their promotion as the cost of creating the art to an acceptable quality is prohibitive. Although television media itself can be purchased in such a targeted manner today, such as in running commercials on individual cable channels in individual markets, luxury brands and stores that are image conscious simply cannot have art being used in their promotions that is inferior or of a lesser production value than the brands that are seen nationally, and capable or affording national level marketing and productions. It is for these industries, too small to afford such costs, but of an image level that they cannot compromise and therefore they do not do it at all, are the preferred clients of the method of the present invention

### The Coop Production

Using the jewelry industry as our example, there are numerous small but upscale brands with advertising budgets (total) of only a few hundred thousand dollars. The retailers, hereafter called DISTRIBUTORS, of these BRANDS, other than the larger chains or franchises, also have small marketing budgets for promoting their own store name and merchandise in their local markets. These two entities have a mutual interest in the others' promotion and success, one carrying the brand and therefore needing it to be popular, and the other providing the brand to the retailers, and needing those stores to be effective regional sellers of their products.

To date, much advertising in these scenarios follows a coop arrangement wherein the “brands” (product manufacturers or distributors,) provided the advertising and the “DISTRIBUTORS” or regional points-of-purchase would pay to be listed or featured on the national advertising run by the “brands.” (With regards to other industries following the model, “brands” refers to the products and “retailers” refers to the regional or local “points-of-purchase” where those brands are sold.) Aside from newspaper advertising and catalogs, and perhaps low budget and potentially image-damaging local television commercials, the local retailers do not have access to costly creative, such as filmed, network quality television commercials. The following method accomplishes this feat in finding new common ground between the marketing needs of the brands and the retailers, and exploiting that in a new way.

In shooting the creative, or television commercial in this case, one commercial must be produced at one time with the intention of providing potential promotion of many brands, and many retailers, from the same shoot. In doing so, every major “brand” should be included in the production, meaning that selected important items from every “brand” should be available at the time of production. Within the context of the production, visuals should be planned, or storyboarded, that allow for product to be “changed” and the visual re-shot, without changing the essence of the visual with regards to story or visual concept. In doing so, a final production of many shots results, where the “same commercial concept and storyboard” can be edited with the same models or actors featured (for instance,) in the same situations and scenes, with the change of products within the visuals (as an option) being the single context variable within the creative (or art.)

In essence, the same commercial concept and storyboard, can be edited in to potentially hundreds of different “versions” as a large array of potential combinations of available brands becomes possible, as each brand was photographed in each setting, or scene, of the production toward the end of this option and new post production flexibility. For instance, four brands of necklaces, four brands of bracelets and four brands of earrings would potentially allow for 56 different brand-combination edited versions of the same commercial concept, story and/or shoot. Further, the cooperative of the present invention would allow then for a virtually unlimited number of retailers to participate, (again one per TV market recommended,) utilizing as many of the editing combinations as need be, by request of each retailer. The basis of the coop being that in most industries, there are a certain number of most popular manufacturers, or product brands, from which all of the retailers who sell products of that given industry, to select a combination of brands that best suits their own merchandising and marketing needs, from the same list of total “top” brands.

For the DISTRIBUTORS, the option of selecting a personalized combination of brands best suited, or best sold at their particular location, makes the commercial custom to their needs. The new coop arrangement also allows a “role reversal” scenario where the retailer is now empowered to charge the brands to be featured within their marketing, as the commercials may be placed locally/regionally by the retailers, allowing for a customized network level filmed commercial, to appear to be their own, wholly owned local commercial.

The author recommends a customized use of voice over and at least one visual specific to the retailer's location, to further enhance the illusion that the filmed spot was produced entirely for this one retailer's use. Naturally, as the commercial is the same story for each retailer, one retailer per TV market running the commercial is recommended.

In editing, a non-linear editing image processing apparatus may be employed in digitizing, and cataloging selected takes from a shoot based on this coop, for easy and quick assemblage of spot versions by assigned “take” number, which is based on the brand and product feature in a take, and which visual or shot in the commercial concept and storyboard, that product is chosen to be featured within.

A further enhancement of the present invention recommended is the use of margins, or letterbox formatting in the commercial's final form, to allow for on-screen slating of the retailer's store name above or below the visuals (or filmed images,) to further enhance the “personalized” nature of the commercial. Further, as each BRAND is featured within the commercial visuals, margin space may be used to feature the logo or name of the brand as it occurs on screen, for further brand identification.

For the producer of such a coop commercial, the economies and options are new, and potentially excellent: A single “shoot” can provide the art necessary for a myriad of commercial versions, so the only work remaining would be the additional editing, or “post production” necessary to edit the multiple versions tailored to, and featuring the name of, each participating retailer, again their store name may be “slated” at the end of the commercial visually and/or audibly, or their name could appear on screen during all or a larger portion of the commercial, or their name and store(s) could be featured within the actual main body of the commercial, (by perhaps having a visual shot of the store itself edited in to the visuals of the commercial and/or by having their retailer brand name mentioned within voice over, etc..)

Likely is the use of the coop spot both regionally and nationally, financed separately by retailers, or distributors, and nationally by a group of brands, an industry guild or consortium. The brands themselves featured, would likely participate financially in all versions broadcast to the public. Industry GROUPS would likely be the determination of both participating brands and distributors, of a coop production based on the present invention.

### DESCRIPTION OF THE DRAWINGS

FIG. 1 Details the aspects of, and creation flow of, a variable commercial based on the present invention from initial brand participants supplying item(s) for inclusion in the commercial, to the delivery of final edited versions to retailers who ordered specific versions of the commercial for their local promotion and placement on broadcast TV and/or cable TV, in-store use, and use on their store WEB SITE as streaming video content.

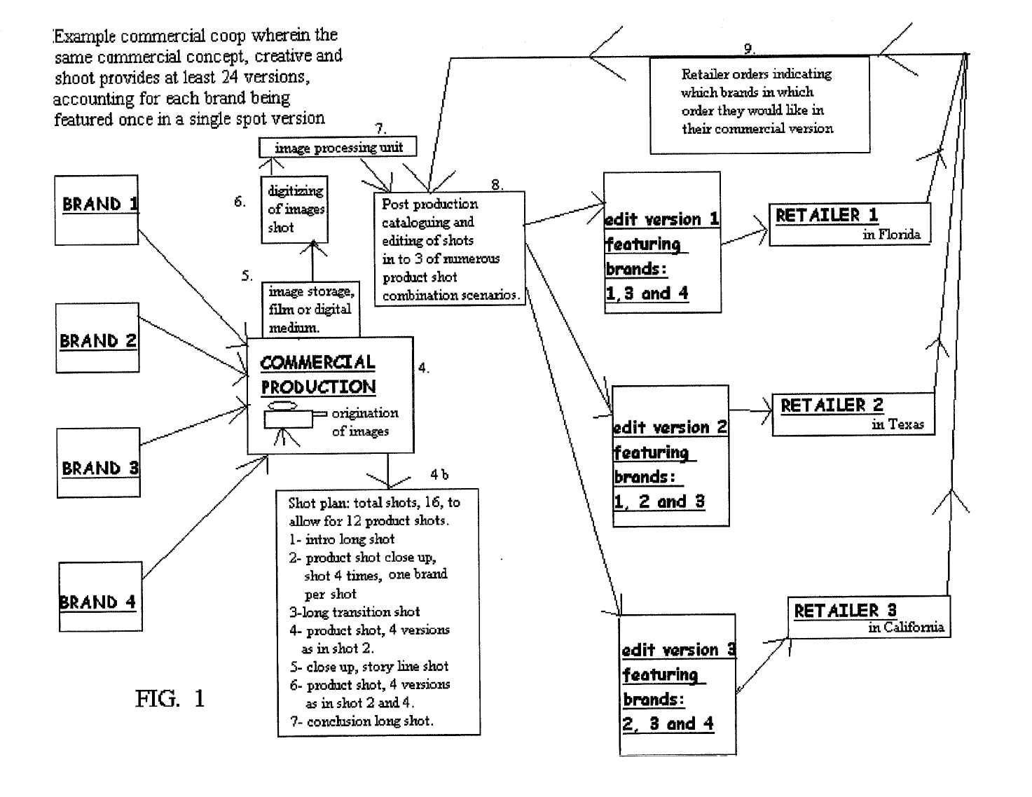

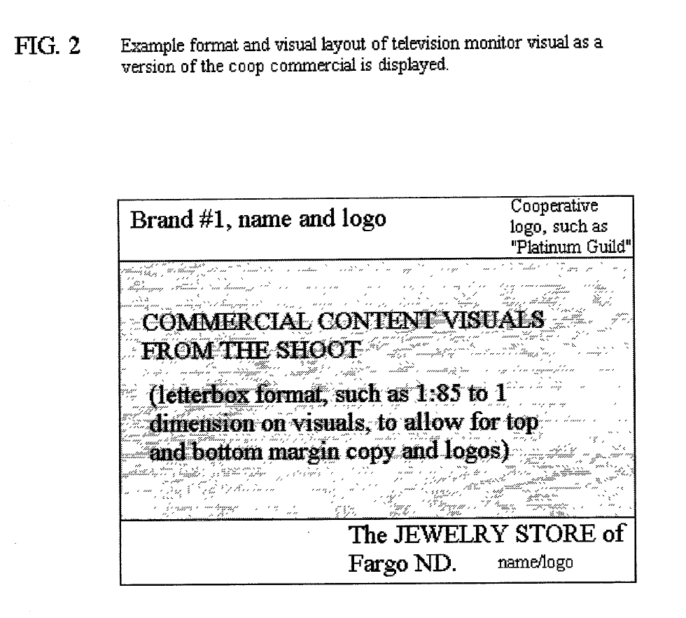

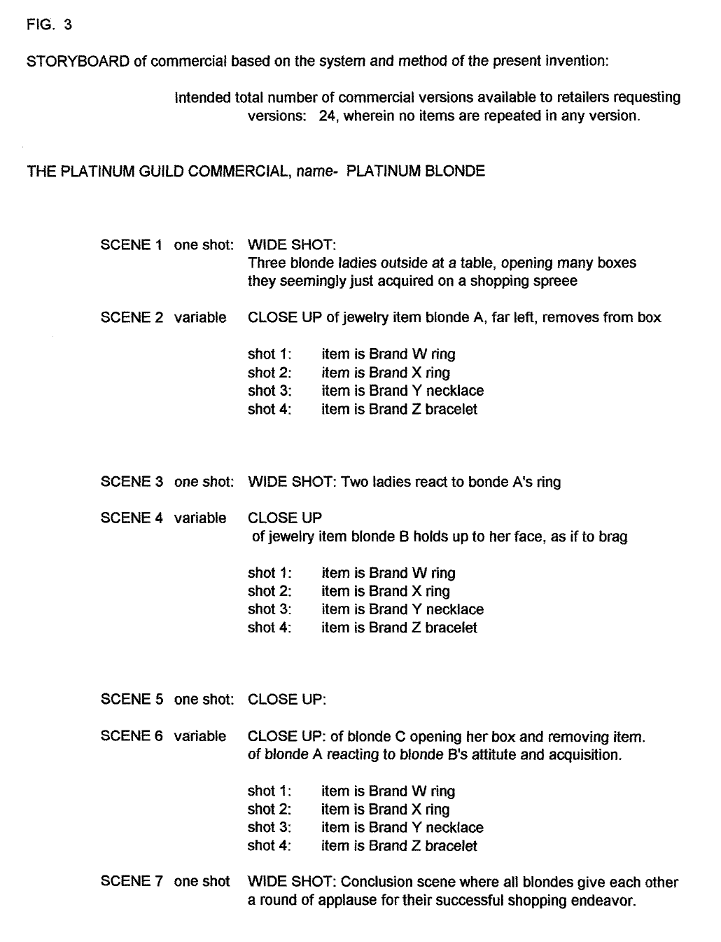

From left to right:

Brands 1,2,3 and 4 supply a single item each for inclusion in the coop commercial version options. Any brand could naturally provide more items to the shoot, selectively.

Commercial production, 4, incorporates those brands in to individual product shots, as included in the commercial concept storyboard, 4b, and all visuals from the commercial are stored as filmed or video images, in an image storage medium such as film emulsion or digital or analog memory medium.

Non-digital originated images are digitized in analog to digital processing unit 6.

Digital images from production 4, are then maintained in the internal memory of non-linear editing, image process unit, 7.

Digital cataloguing and non-linear assemblage of commercial versions, based on RETAILER commercial version order, 9, occurs in post production editing, 8.

Initial orders from three retailers in different states, FL, TX and CA, lead to assemblage of three versions of the single concept, and single shoot commercial; these versions involve one featuring brands 1,3, and 4, one version featuring brands 1,2 and 3, and a third version featuring brands 2,3 and 4, in those exact brand sequences.

Retailer 1, 2 and 3 receive their final commercial versions by digital storage medium such as CD or tape, analog storage medium such as tape, or as digital data transmitted to them through the Internet or other digital transmission means. Then, the retailers may provide their version of the commercial for subsequent broadcast, cablecast or web-cast by advertising distribution facilities in their respective regions.

FIG. 2.

FIG. 2 details a suggested format configuration for final visuals related to versions of commercials produced in accordance with the present invention.

From top to bottom:

TOP MARGIN provides a horizontally proportioned space, preferably black, in which white or color type and/or logo elements (knocked out or black margin, “K/O”) may promote a cooperative or affiliation related to those being promoted in the commercial, (screen right,) and a space for brand names and/or logos to appear during the period of the commercial in which their product may be on screen.

SCREEN CENTER is the “letterboxed” image area for live action visuals related to the commercial to be featured. A 1:85 to 1 or 1:65 to 1 image ratio is suggested, to be consistent with familiar letterboxing proportions seen generally on television.

BOTTOM MARGIN provides a second (black) margin area for featuring the name of the regional jeweler, and their logo, for instance; again white or color type dropped out (K/O) of the black margin.

Where elements are featured where on-screen is optional. This scenario demonstrates an opportunity for one store, one cooperative (guild or affiliation group, etc.,) and 3 brands to receive name and/or logo exposure during a single play of this commercial version, while not compromising the screen time of the live action images in SCREEN CENTER

FIG. 3

Is a sample rough “storyboard” related to shooting a variable commercial based on the present invention. Naturally, as many brands or items may be included as desired in the cooperative production; four items are demonstrated m this figure, each being provide from a different brand name manufacturer.

With three scenes in which variable items are featured, four items being involved, and a commercial that must not repeat any one item twice, the total number of possible versions from this particular production would be 24: (The total number of items, multiplied by the total number of variable scenes, multiplied by 2.)

What is claimed, is:

1. A television commercial having selective variability, wherein the capture and editing of visuals related to scenes within said commercial provides for multiple potential versions of said commercial.

2. A commercial as in claim 1, wherein creative content within sequential scenes is unchanged between said versions, such that said versions would be generally perceived as the same commercial.

3. A commercial as in claim 1, wherein said variability is caused by the substitution of selected items featured within said visuals.

4. A commercial as in claim 1, wherein said visuals are digitized and provided to an image processing unit for assemblage in creating said versions.

5. A commercial as in claim 3, wherein said items are products related to commercial brands which are members of a cooperative comprised of brands and distributors of products related to said brands.

5. The commercial as in claim 3, wherein the total number of said versions is potentially at least the total number of said scenes where variable items are featured, multiplied by the total number shots executed per scene in which selected items were replaced, then multiplied by 2.

6. A method for producing a variable, cooperative television commercial wherein the recording and editing of visuals for potential inclusion in said commercial allows for multiple potential versions of said commercial, and wherein said versions are based on variation within said visuals including the substitution of selected items featured within said visuals.

7. A method as in claim 6, wherein the creative presentation and essence of said commercial is unchanged between said versions, such that said versions would be generally perceived as the same commercial.

8. A method as in claim 6, wherein said items are products associated with members of a cooperative.

9. A method as in claim 6, wherein said versions are selectively determined and purchased by selected distributors of said items.

10. A method as in claim 6, wherein said commercial may be presented in a letterbox, cropped format to allow for other information related to said cooperatives members to be featured in the resulting margins created by said format.

11. A system for creating marketing cooperatives comprising: A television production wherein the origination and recording of visuals related to said production allows for multiple variations of selected sequential scenes within said production; and an editing aspect, wherein said scenes comprised of said visuals may be assembled in to selected, distinct versions of said production.

12. A system as in claim 11, wherein the change of selected items within said visuals constitutes said variations.

13. A system as in claim 12, wherein said items include products associated with members of said cooperatives.

14. A system as in claim 13, wherein said cooperatives include entities related to production and distribution of items specific to a particular industry or commercial venue.

15. A system as in claim 11, wherein the membership of said cooperatives may be defined by said commercial.

16. A system as in claim 11, wherein the creative content and direction of said scenes remains unchanged between said versions.

17. A system as in claim 11, wherein said cooperatives selectively include brand name product manufacturers and distributors of products of said manufacturers, including selected retail points of purchase.

18. A system as in claim 17, wherein said cooperatives are preexisting groupings of said manufacturers and said distributors.

19. A system as in claim 11, wherein said editing aspect includes cataloguing said visuals as digital data allowing for computerized reference by selected coding reference in assembling versions of said production.
